(19) United States
(12) Patent Application Publication
(10) Pub. No.: US 2004/0221274 A1
(43) Pub. Date: Nov. 4, 2004

(54) Source-transparent endian translation

(76) Inventors: Kevin W. Bross, Tigard, OR (US); Mark L. Skarpness, Hillsboro, OR (US); Douglas P. Bogia, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/429,472

(22) Filed: May 2, 2003

(51) Int. Cl. G06F 9/45

(52) U.S. Cl. 717/136

(57) ABSTRACT

Embodiments of the invention relate to a method, apparatus, and system for source-transparent endian translation. More particularly, embodiments of the invention relate to allowing source code that was previously designed for Big Endian processors to be converted and recompiled to run on Little Endian processors, or vice-versa. In one embodiment, a compiler receives Big Endian source code that is operable on a processor that operates in a Big Endian mode. A source-transparent endian translator works with the compiler or as part of it to translate the Big Endian source code received by the compiler into a Little Endian code format; the Little Endian code format is then further processed by the compiler into Little Endian machine code that is operable on a processor which operates in a Little Endian mode.

### BACKGROUND

1. Field

Embodiments of the invention relate to the field of the computer programming arts. More particularly, embodiments of the invention relate to a method, apparatus, and system for source-transparent endian translation.

2. Description of Related Art

Applied to processors, the term endianness refers to the order in which multi-byte entities are stored or transmitted. Big Endian processors store the most significant (i.e. the biggest) byte (MSB) first, while Little Endian processors store the least significant (i.e. the littlest) byte (LSB) first. For example, the number 0×12345678 is stored 12 34 56 78 on a Big Endian processor, whereas it is stored as 78 56 34 12 on a Little Endian processor. Interestingly, the terms Big Endian and Little Endian are borrowed from Jonathan Swift's Gulliver's Travels, in which people were divided into two camps: those who ate their eggs by opening the ‘big’ end and those who ate their eggs by opening the ‘little’ end.

Today, different types of processors utilize either Big Endian or Little Endian programming schemes. Some processors are bi-endian (capable of operating in Big Endian or Little Endian mode); these typically choose their endian mode on a per-process or per-memory region basis. Unfortunately, a problem arises when code written for one type of processor operating in one type of endian mode is attempted to be ported to another type of processor operating in a different endian mode. For example, many software programs designed for use on a Big Endian type processor cannot be utilized on a Little Endian type processor. This endian issue is a major impediment that prevents companies from being able to switch to a more suitable processor if that processor has a different endian orientation. This is especially true in the communications and embedded market, where prior choices to use Big Endian processors relegate many of these solutions to selecting among the Big Endian processor choices and prevents them from choosing from the larger pool of Little Endian and Big Endian processors.

Large companies involved in network communications presently have huge software investments in Big Endian code. It may be beneficial for these companies to leverage the cost-benefit advantages of today's commonplace high-speed Little Endian processors. Unfortunately, in view of the time and resources it would take for these companies to rewrite their code for Little Endian processors and to perform the necessary rigorous testing required to make sure that the rewritten code does not introduce any bugs into their software, this endeavor would most likely be cost-prohibitive.

Various attempts utilizing a wide variety of different approaches have been tried in the past to find a way to adapt Big Endian code to Little Endian processors, however, these attempts have been largely unsuccessful. For example, although macros and other routines exist today to mask endian dependencies, these macros and other routines are of little use to companies with large amounts of legacy code written without these practices. As previously discussed, companies cannot afford to go through millions of lines of code searching for the parts of code that need to be changed. This is because all of the endian dependencies may not be adequately found and fixed, and rigorous testing would be required to make sure that the rewritten code does not introduce any bugs into the software. Thus, this type of endeavor would involve great amounts of manual searching and would most likely be cost prohibitive.

Additionally, it should also be noted, that several approaches have been unsuccessfully tried to automate the conversion of Big Endian code into Little Endian code. Some of these approaches look for specific, common routines and replace those instances; but these approaches do nothing about the more uncommon instances, making this type of approach inadequate. Other automated approaches attempt to use artificial intelligence to analyze sophisticated patterns and cross-references to identify endian-sensitive code and produce modified code. Unfortunately as with the other approaches, these automated approaches do not provide a full solution to the problem of translating Big Endian code into Little Endian code, and further, detrimentally introduce voluminous quantities of bugs into the software programs to be converted due to inconsistent endian conversion.

### BRIEF DESCRIPTION OF THE DRAWINGS

FIG. 1 shows a partial block diagram of an example of a computer system configuration, in which embodiments of the invention may be practiced.

FIG. 2 is a block diagram illustrating an example of an architecture, including a processor having a compiler, which may be utilized to implement aspects of a source-transparent endian translator, according to one embodiment of the invention.

FIG. 3 is an example of a program written for a processor that utilizes a Big Endian coding scheme.

FIG. 4A is an example of resultant output for the program of FIG. 3 when implemented properly on a Big Endian processor.

FIG. 4B is an example of resultant output for the program of FIG. 3 when it is improperly implemented on a Little Endian processor.

FIG. 5 is a block diagram illustrating one example of a series of functions performed by the compiler and the source-transparent endian translator to translate Big Endian source code to Little Endian machine code, according to one embodiment of the invention.

FIG. 6 is a flow diagram illustrating a process of source-transparent endian translation, according to one embodiment of the invention.

FIG. 7 is a table illustrating examples of commands that require endian translation and commands that do not require endian translation, according to one embodiment of the invention.

FIG. 8 is an example of a program originally written for a processor utilizing a Big Endian coding scheme, that has been translated into intermediate code by the source-transparent endian translator, according to embodiments of the invention, such that it can be compiled to run on a Little Endian processor.

FIG. 9A is an example of resultant output for the untranslated program, when implemented on a Big Endian processor.

FIG. 9B is an example of resultant output for the translated program of FIG. 8, when it is properly implemented on a Little Endian processor.

FIG. 10 is an example of an instruction to aid in source-transparent endian translation that may be implemented as part of an instruction set within a processor, according to one embodiment of the present invention.

### DESCRIPTION

In the following description, the various embodiments of the invention will be described in detail. However, such details are included to facilitate understanding of the invention and to describe exemplary embodiments for employing the invention. Such details should not be used to limit the invention to the particular embodiments described because other variations and embodiments are possible while staying within the scope of the invention. Furthermore, although numerous details are set forth in order to provide a thorough understanding of the embodiments of the invention, it will be apparent to one skilled in the art that these specific details are not required in order to practice the embodiments of the invention. In other instances details such as, well-known methods, types of data, protocols, procedures, components, electrical structures and circuits, are not described in detail, or are shown in block diagram form, in order not to obscure the invention. Furthermore, embodiments of the invention will be described in particular embodiments but may be implemented in hardware, software, firmware, middleware, or a combination thereof.

Generally, embodiments of the invention relate to a method, apparatus, and system for source-transparent endian translation. More particularly, embodiments of the invention relate to a method, apparatus, and system to allow source code that was previously designed for Big Endian processors to be converted and recompiled to run on Little Endian processors. In fact, embodiments of the invention provide for source-transparent endian translation, in that, the original commands of the source code that is having its endianness translated (from Big to Little, or vice-versa) are themselves not modified. In one particular embodiment, a compiler receives Big Endian source code that is operable on a processor that operates in a Big Endian mode. A source-transparent endian translator translates the Big Endian source code received by the compiler into a Little Endian code format, the Little Endian code format is then further processed by the compiler into Little Endian machine code that is operable on a processor which operates in a Little Endian mode.

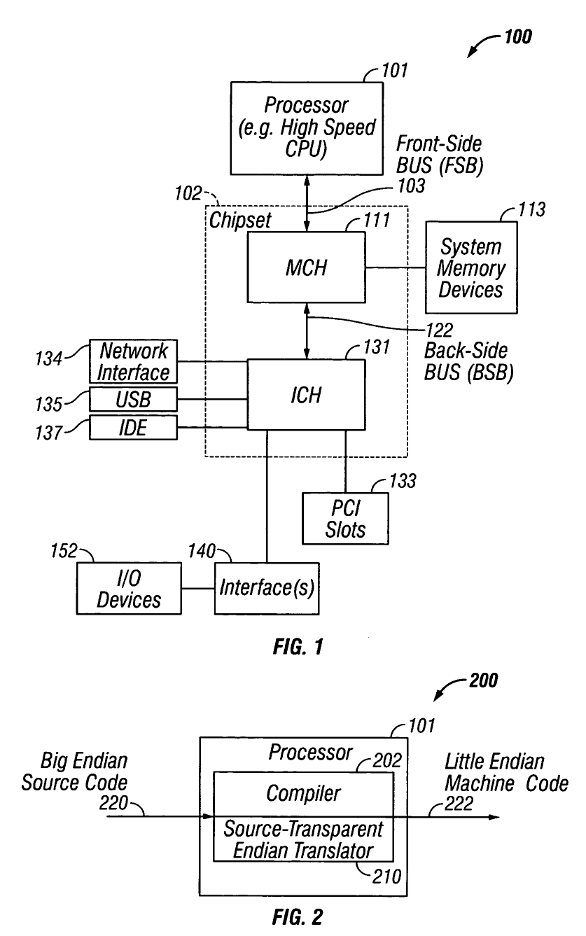

FIG. 1 shows a partial block diagram of an example of a computer system configuration, in which embodiments of the invention may be practiced. The system configuration 100 includes at least one processor 101 such as a central processing unit (CPU) (e.g. a high speed CPU), a memory control hub (MCH) 111, system memory devices 113, and an Input/Output (I/O) control hub (ICH) 131. The combination of the MCH 111 and ICH 131 is sometimes termed a chipset 102. The chipset 102 may be one or more integrated circuit chips that acts as a hub or core for data transfer between the processor and other components of the computer system 100. Further, the computer system may include additional components (not shown) such as a co-processor, modem, etc.—this being only a very basic example of a computer system.

The CPU 101 is coupled to the MCH 111 by the front-side bus (FSB) 103 and the MCH 111 is coupled to the ICH 131 by a hub link 122 (sometimes referred to as the back-side bus). The MCH 111 performs functions often termed “northbridge functionality”; and the ICH 131 performs functions often termed “southbridge functionality.”

For the purposes of the present specification, the term “processor” or “CPU” refers to any machine that is capable of executing a sequence of instructions and shall be taken to include, but not be limited to, general purpose microprocessors, special purpose microprocessors, application specific integrated circuits (ASIC), multi-media controllers, signal processors and microcontrollers, etc. In one embodiment, the CPU 101 is a general-purpose high speed microprocessor that is capable of executing an Intel Architecture instruction set. For example, the CPU 101 can be one of the INTEL® PENTIUM® classes of processors, such as an INTEL® Architecture 32-bit (IA-32) processor (e.g. PENTIUM® 4M).

The CPU 101, the ICH 131, and other components access the system memory devices 113 via the MCH 111. The MCH 111, in one embodiment, is responsible for servicing all memory transactions that target the system memory devices 113. The MCH 111 can be a stand-alone unit, an integrated part of a chipset, or a part of some larger unit that controls the interfaces between various system components and the system memory devices 113.

The system memory devices 113 can include any memory device adapted to store digital information, such as static random access memory (SRAM), dynamic random access memory (DRAM), synchronous dynamic random access memory (SDRAM), and double data rate (DDR) SDRAM or DRAM, etc. Thus, in one embodiment, system memory devices 113 include volatile memory. Further, system memory devices 113 can also include non-volatile memory such as read-only memory (ROM) (e.g. including basic input/output system (BIOS) ROM).

The ICH 131 provides the interface control between the MCH 111 and various I/O devices, interfaces, and ports which may include peripheral component interconnect (PCI) slots and PCI agents 133, a network interface 134 to communicate with a network using a standard network protocol, at least one USB port 135, at least one integrated drive electronic (IDE) interface 137 (e.g. for a hard drive), and at least one interface 140 having at least one I/O device 152 coupled thereto. Alternatively, I/O devices 152 may be directly coupled to the ICH 131. It should be appreciated that there are a wide variety of different types of I/O interfaces and devices that may be utilized. Examples of I/O devices may include any I/O devices to perform I/O functions. For example, I/O devices may include a monitor, a keypad, a modem, a printer, storage devices (e.g. Compact Disk ROM (CD ROM), Digital Video Disk (DVD), hard drive, floppy drive, etc.) or any other types of I/O devices, e.g., controllers for input devices (mouse, trackball, pointing device), media cards (e.g. audio, video, graphics), etc. Further any sort of suitable interface(s) 140 may be utilized.

The basic computer system configuration 100 of FIG. 1 is an example of one type of computer system that may be utilized to allow source code that was previously designed for Big Endian processors to be converted and recompiled to run on Little Endian processors (and vice-versa), and thus the computer 100 may act as compiler computer for generating software. It should be appreciated by those skilled in the art that the FIG. 1 computer system configuration 100 is only one example of a basic computer system and that many other types and variations are possible. Further, those skilled in the art will recognize that the exemplary environment illustrated in FIG. 1 is not intended to limit the embodiments of the invention. Moreover, it should be appreciated that in addition to, or in lieu of, the single computer system configuration 100, clusters or other groups of computers (similar to or different from computer system configuration 100) may be utilized in practicing embodiments of the invention.

Embodiments of the invention relate to a method, apparatus, and system to allow source code that was previously designed for Big Endian processors to be converted and recompiled to run on Little Endian processors. In fact, embodiments of the invention provide for source-transparent endian translation, in that, the original commands of the source code that is having its endianness translated (from Big to Little, or vice-versa) are themselves not modified.

Turning now to FIG. 2, FIG. 2 is a block diagram illustrating an example of an architecture 200, including a processor 101 having a compiler 202, which may be utilized to implement aspects of a source-transparent endian translator 210, according to one embodiment of the present invention. As shown in FIG. 2, the processor 101 includes a compiler 202 having a source-transparent endian translator 210. In this configuration, Big Endian source code 220 that enters the processor 101 for processing, may be compiled by the compiler 202 and subject to endian translation by the source-transparent Endian translator 210, such that the Big Endian source code is converted to Little Endian machine code 222 for use by a Little Endian processor.

While embodiments of the invention and its various functional components have, and will be described, in particular embodiments, it should be appreciated these aspects and functionalities can be implemented in hardware, software, firmware, middleware or a combination thereof.

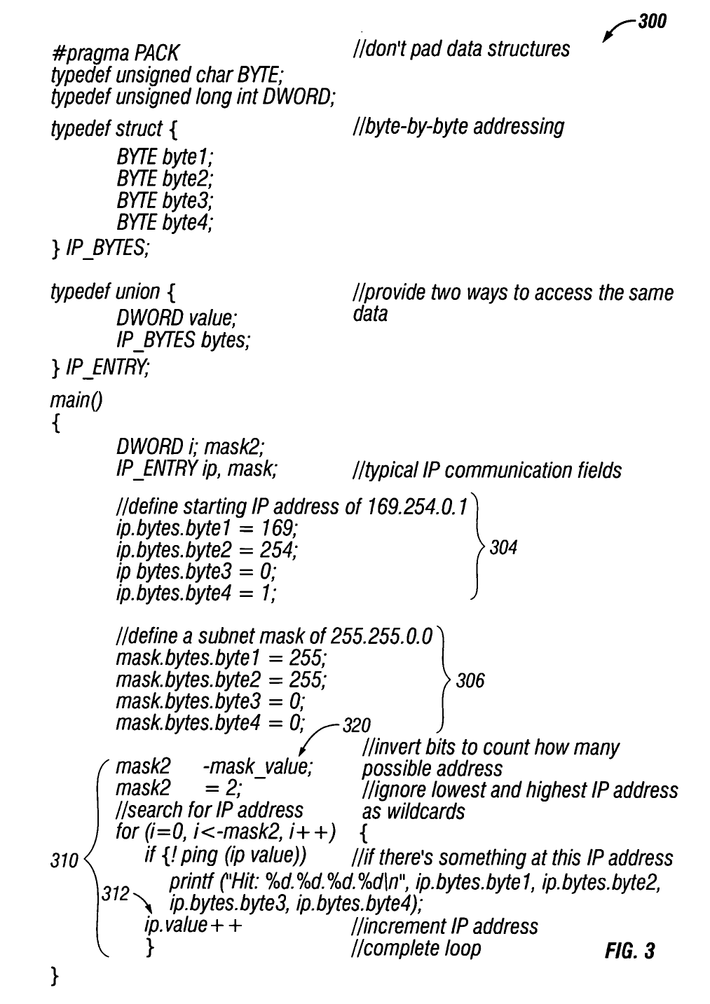

To illustrate the differences between how a program written in accordance with a Big Endian coding scheme is processed by a Big Endian processor and a Little Endian processor, FIG. 3 will be discussed. FIG. 3 is an example of a program written for a processor that utilizes a Big Endian coding scheme.

Basically, the program 300 of FIG. 3 utilizing a Big Endian coding scheme is a simple C program to search for and identify devices within a subnet, and to then print out the identified devices of the subnet. Those skilled in the art will note that this invention can apply to multiple computer languages and C is used as an example only. Because the commands and functions of this simple exemplary C program are readily known to those of skill in the art, only brief reference will be given to pertinent parts of the program 300 that will be useful in explaining aspects of the embodiments of the present invention. As can be seen in program 300, at code section 304, IP addresses are defined as 169.254.0.1. With this IP address, the first two bytes (169.254) define the subnet to be searched and the last two bytes are used to identify devices within the subnet that is to be searched, as will be discussed. At code section 306, a masking scheme is set up to hold the first two bytes of the IP address constant and to allow for the variation of the last two bytes of the IP address such that addresses for devices in the subnet can be incremented and searched. Code section 310 cycles through the IP addresses to search for and identify devices within the subnet and to then print out the identified devices of the subnet. Particularly, the command ip.value+ 312 increments the address.

Although this Big Endian program (e.g. Big Endian source code) works suitably well on a Big Endian processor, it does not work suitably well on a Little Endian processor. The endian issue or discrepancies that make this program 300 suitable for a Big Endian processor and not a Little Endian processor, occur in two places in the example program 300. The first endian-sensitive instance occurs at line 320 where mask2 is assigned and inverted. The second endian-sensitive instance is the last line of code, command 312, in which the IP address is incremented.

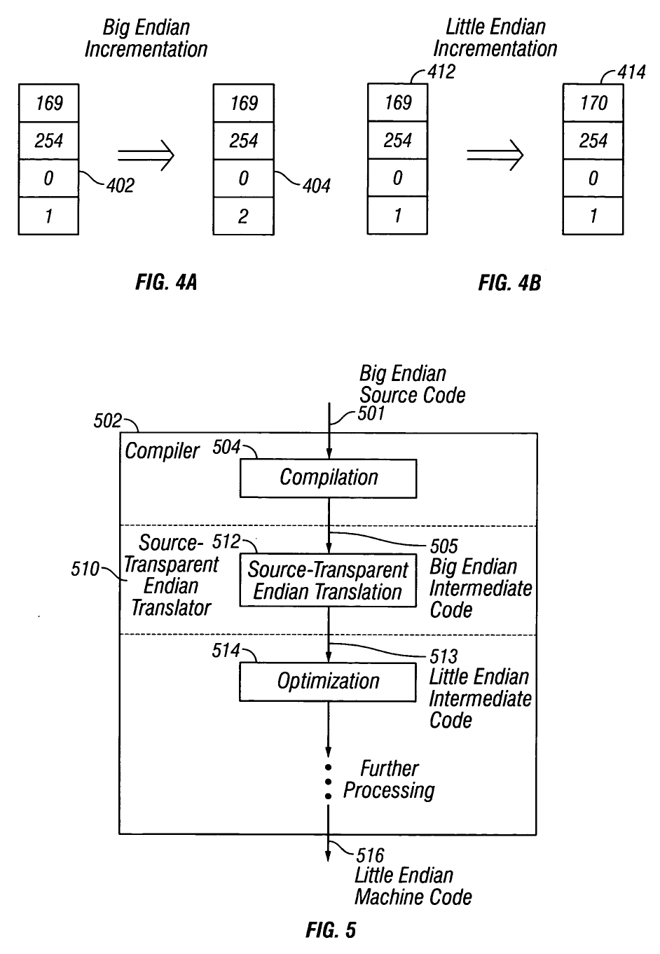

With reference now to FIGS. 4A and 4B, examples of how the program 300 works suitably well on a Big Endian processor and how it does not work suitably well on a Little Endian processor, will now be presented. FIG. 4A is an example of resultant output for the program of FIG. 3 when implemented properly on a Big Endian processor. As shown in FIG. 4A, in data block 402 the IP address starts at 169.254.0.1 and properly increments in accordance with program 300 to 169.254.0.2 (as shown in data block 404). Thus, a new device is searched for and possibly identified IP address 169.254.0.2 and if identified, its identification is information printed out.

On the other hand, FIG. 4B is an example of resultant output for the program of FIG. 3 when implemented improperly on a Little Endian processor. As shown in FIG. 4B, in data block 412 the IP addresses start at their correct initial IP address of 169.254.0.1; but then improperly increment on the Little Endian processor in accordance with program 300 to 170.254.0.1 (as shown in data block 414). This is due to the nature of Little Endian processors to increment the byte in the lowest memory address first. Thus, a new device is searched for, but in an entirely different subnet. Accordingly, the program 300 due to the endian issue does not execute properly on a Little Endian processor.

As will now be discussed in more detail, a source-transparent endian translator, according to embodiments of the invention, addresses this endian issue such that Big Endian source code can be converted and recompiled to run on Little Endian processors. Turning now to FIG. 5, FIG. 5 is a block diagram illustrating one example of a series of functions performed by a compiler 502 and a source-transparent endian translator 510 to translate Big Endian source code to Little Endian machine code, according to one embodiment of the invention.

As shown in FIG. 5, Big Endian source code 501 enters the compiler 502 and undergoes compilation (block 504) resulting in Big Endian intermediate code 505. The Big Endian intermediate code 505 enters the source-transparent endian translator 510 and undergoes endian translation (block 512) such that it is translated into Little Endian intermediate code 513. The Little Endian intermediate code 513 then undergoes optimization (block 514), and may undergo further processing typically associated with a compiler, such that Little Endian machine code 516 is yielded.

Thos skilled in the art will recognize that the process previously defined with reference to FIG. 5, and as will be discussed, for compiling, may also be applied to interpreted code as well. For example, an interpreter may also be utilized to perform interpretation functions to generate interpreted code, as well. Moreover, as should be appreciated by those skilled in the art, although the term “machine code” is used, it should be appreciated that “machine code” also encompasses low-level interpretive code, pseudo-machine code, as well as other variants.

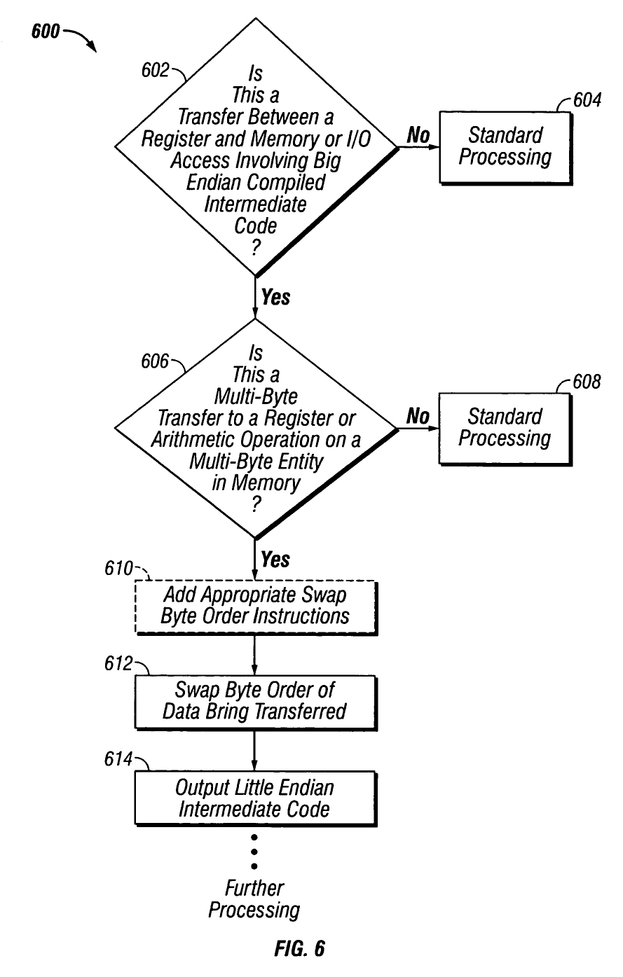

Turning now to FIG. 6, FIG. 6 is a flow diagram 600 illustrating a process of source-transparent endian translation, according to one embodiment of the present invention. Particularly, FIG. 6 illustrates a process of source-transparent endian translation that may be performed by the source-transparent endian translator 510 of FIG. 5 to translate Big Endian compiled intermediate code into Little Endian intermediate code. At block 602, the process 600 determines whether a transfer of data between a register and either memory or an input/output (I/0) access involves Big Endian compiled intermediate code. If not, standard processing is continued (block 604). However, if Big Endian compiled intermediate code is involved, then, at block 606, the process 600 next determines whether or not this is a multi-byte transfer to a register or an arithmetic operation on a multi-byte entity in memory. If not, standard processing is continued (block 608). The indication of whether Big Endian code is involved can be made via environment variables, make file additions or other methods.

If a multi-byte data transfer involving Big Endian compiled intermediate code is to be performed, then the process 600 swaps the byte order of the data being transferred (block 612). In one optional embodiment, the process 600 adds or inserts appropriate swap byte order instructions in order to implement the swapping of the byte order of the multi-byte data transfer (block 610). It should be appreciated by those of skill in this art that any number of swap byte order instructions may be used. For example, a BSWAP (byte swap) instruction, a ROR (rotate operand right) instruction, an XCHG (exchange) instruction, or any suitable instruction may be used. However, it should be appreciated that the original commands of the source code that is having its endianness translated (e.g. from Big to Little, or vice versa) are themselves not modified, such that the endian translation is transparent. Further, as will be discussed in more detail later, in some embodiments, a specialized swap prefix instruction may be part of the instruction set architecture of the processor itself to gain even more efficiency. At block 614, the process 600 outputs Little Endian intermediate code for further processing by the compiler. For example, process 600 particularly illustrates the output of Little Endian intermediate code, which as in FIG. 5, may then undergo optimization such that Little Endian machine code is ultimately yielded.

It should be appreciated by those skilled in the art that the source-transparent endian translator 510 of FIG. 5, along with the process 600, previously described, can just as easily be implemented in reverse to translate Little Endian source code into Big Endian machine code.

Thus, as previously described, embodiments of the invention relate to a compiler-based source-transparent endian translator to allow Big Endian code to be converted and re-complied to run on a Little Endian processor (e.g. a high-speed Intel processor, such as the PENTIUM 4) without any modification to the original commands of the source code. This is accomplished by adjusting and compensating for Big Endian memory and I/O transactions, while at the same time retaining the Big Endian memory model for Little Endian processors. More specifically, as previously discussed, every time a multi-byte value is read from memory to a register or written from a register to memory, the bytes are swapped. I/O accesses are treated the same way as memory accesses and are adjusted the same way. Thus, throughout the text, any discussion about memory accesses also applies to corresponding I/O accesses, unless explicitly noted otherwise.

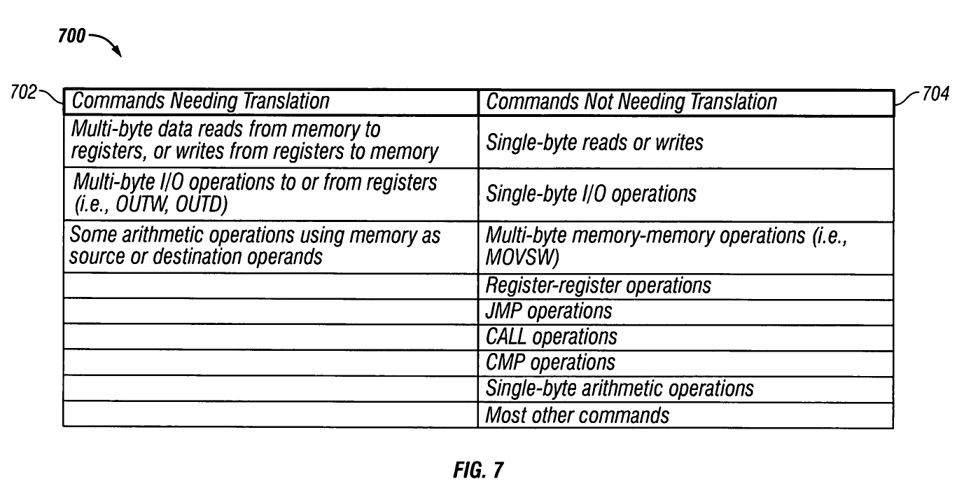

Turning briefly to FIG. 7, FIG. 7 is a table 700 illustrating some examples of commands that require Endian translation and commands that do not require Endian translation, according to one embodiment of the invention. Particularly, column 702 of the table 700 illustrates commands that require Endian translation. As shown in column 702, the following commands require Endian translation: multi-byte data reads from memory to registers, or writes from registers to memory; multi-byte I/O operations to or from registers (e.g. OUTW (out word), OUTD (out double word)); as well as some arithmetic operations using memory as source or destination operands. On the other hand, as shown in column 704, the following commands do not require Endian translation: single-byte reads or writes; single-byte I/O operations; multi-byte memory-memory operations; register-register operations; JMP operations (e.g. jump operations); CALL operations; single-byte arithmetic operations; as well as most other commands.

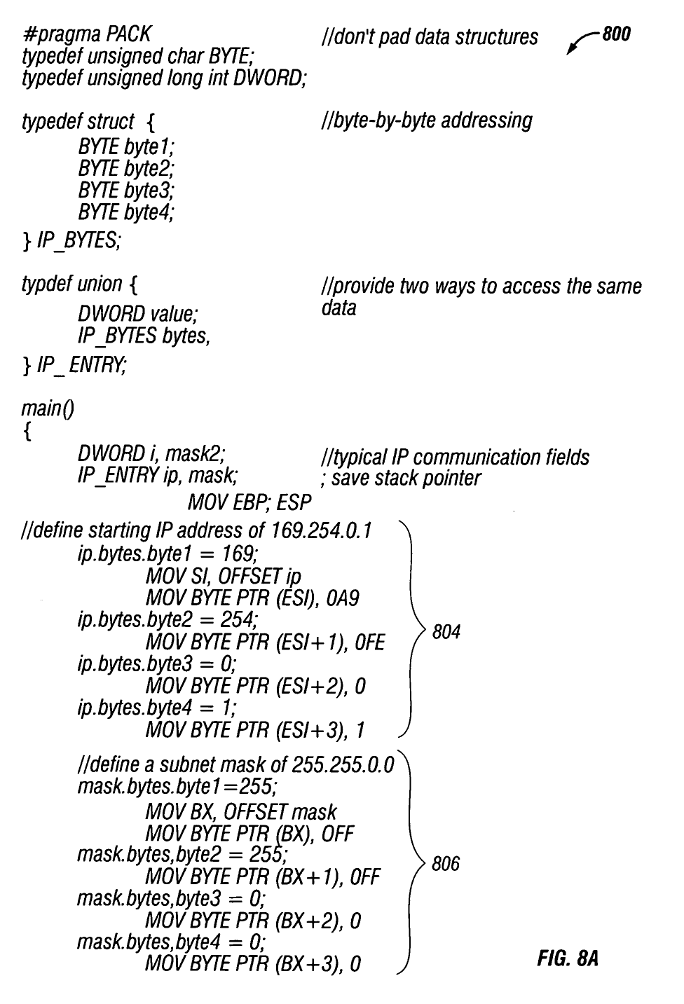

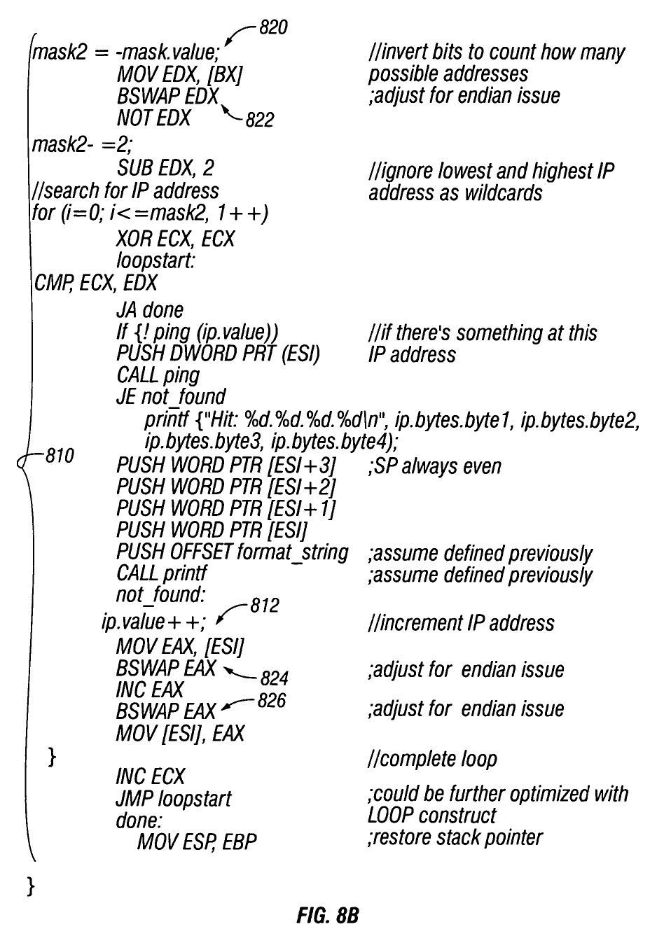

An example will now be provided of how, in one embodiment, the source-transparent endian translator adds appropriate swap byte order instructions in order to swap the byte order of a multi-byte data transfer such that Big Endian intermediate code is properly translated into Little Endian intermediate code that can then be further compiled into Little Endian machine code for use on a Little Endian processor. Turning now to FIG. 8, FIG. 8 is an example of the previously discussed program of FIG. 3 written for a processor utilizing a Big Endian coding scheme, which has been translated by the source-transparent endian translator, according to embodiments of the invention, such that it can now be compiled to run on a Little Endian processor.

FIG. 8 presents substantially the same program as previously discussed in detail with reference to FIG. 3 and therefore, for brevity's sake, much of the discussion with reference to FIG. 3 to describe the operation of program will not be re-discussed. However, the program 800 of FIG. 8 provides some noticeable dissimilarities to the program 300 of FIG. 3. First of all, as should be appreciated by those of skill in the art, the underlying intermediate code (e.g. which may also be termed assembly code, pseudo-assembly code, pseudo code, etc.) has been added in FIG. 8 to the program presented in FIG. 3 to aid in the explanation of the program and to illustrate how it can be compiled into Little Endian intermediate code.

Particularly, the major change to program 800 of FIG. 8 vs. program 300 of FIG. 3 is that appropriate swap byte order instructions, in order to swap the byte order of the multi-byte data transfer, have been added such that the Big Endian intermediate code is properly translated into Little Endian intermediate code that can then be further compiled into Little Endian machine code for use on a Little Endian processor. More particularly, BSWAP instructions are utilized for the byte swapping operations at lines 822, 824, and 826, respectively.

As previously discussed with respect to program 300 of FIG. 3, similarly, the program 800 of FIG. 8 is a simple C program (including intermediate code or pseudo-assembly code) to search for and identify devices within a subnet, and to then print out the identified devices of the subnet. Because the commands and functions of this simple exemplary C program are readily known to those of skill in the art, only brief reference will be given to pertinent parts of the program 800 that will be useful in explaining aspects of the embodiments of the present invention. As can be seen in program 800, at code section 804, IP addresses are defined as 169.254.0.1. Particularly, the first two bytes of the IP addresses define the subnet to be searched and the last two bytes of the IP address are used to identify devices within the subnet that is to be searched, as will be discussed. At code section 806, a masking scheme is set up to hold the first two IP addresses of the subnet constant and to allow for the variation of the last two IP addresses such that the addresses for devices in the subnet can be incremented and searched. Code section 810 cycles through the last two IP addresses to search for and identify devices within the subnet and to then print out the identified devices of the subnet. Particularly, the command ip.value++ 812 increments the last two IP addresses.

As previously discussed with reference to program 300 of FIG. 3, this initial Big Endian program was originally programmed to work for a Big Endian processor, but un-translated, it does not work suitably on a Little Endian processor. As previously discussed with reference to program 300 of FIG. 3, there are two endian issues that make the initial program unsuitable for a Little Endian processor. The first endian-sensitive instance occurs at line 820 where mask2 is assigned and inverted. The second endian-sensitive instance is the last line of code, command 812, in which one of the last two IP addresses is incremented.

In order to resolve the endianness issue such that program 800 can be run on a Little Endian processor, these endian issues are remedied by the source-transparent endian translator, according to embodiments of the invention. Particularly, appropriate swap byte order instructions, in order to swap the byte order of the multi-byte data transfer, have been added such that the Big Endian code is properly translated into Little Endian code that can then be further compiled into Little Endian machine code for use on a Little Endian processor. More particularly, byte swap (e.g. BSWAP) instructions are added for byte swapping operations at lines 822, 824, and 826, respectively.

Even more particularly, firstly, at code section 810, where the bits are inverted to count the total number of possible addresses, a BSWAP instruction at line 822 is added to resolve the endianness issue. By adding the BSWAP instruction at line 822 the multi-byte data in Big Endian format is properly translated to Little Endian format for the inversion function and subsequent subtraction operation. Secondly, at code section 810, where the last two bytes of the IP address are cycled through to search for and identify devices within the subnet and to then print out the identified devices of the subnet, BSWAP instructions at lines 824 and 826 are added to resolve the endianness issue. By adding BSWAP instructions at lines 824 and 826 the multi-byte data in Big Endian format is translated to Little Endian format such that the command ip.value++ 812 increments the IP address properly.

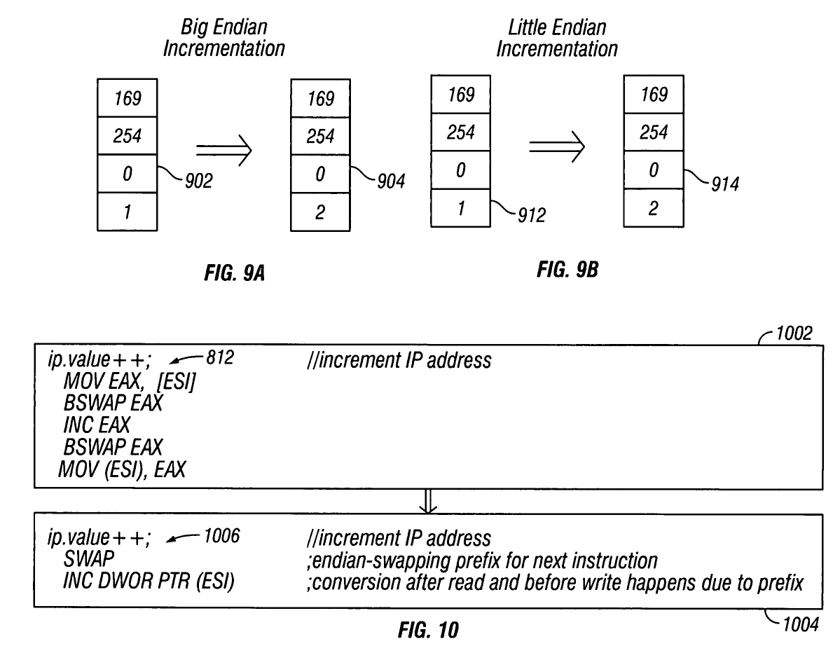

With reference now to FIG. 9A, FIG. 9A is an example of the resultant output for the unmodified program of FIG. 8, without swapping instructions (i.e. it is the same program as previously discussed with reference to program 300, FIG. 3). Thus, FIG. 9A is an example of resultant output for the program 300 of FIG. 3 (i.e. the unmodified program 800 of FIG. 8) when implemented properly on a Big Endian processor. As shown in FIG. 9A, in data block 902 the IP addresses start at their correct IP address of 169.254.0.1 and properly increment in accordance with program 300 to 169.254.0.2 (as shown in data block 904). Thus, a new device is searched for and possibly identified at IP address 169.254.0.2; if identified, its identification information is printed out.

On the other hand, with reference to FIG. 9B, FIG. 9B shows an example of the resultant output for the translated program 800 of FIG. 8, that has undergone translation by the source-transparent endian translator to add appropriate swap byte order instructions in order to swap the byte order of a multi-byte data transfer such that Big Endian intermediate code has been properly translated into Little Endian intermediate code, which is then further compiled into Little Endian machine code for use on a Little Endian processor, such that the Little Endian processor can give the correct output as will be shown.

As shown in FIG. 9B, in data block 912 the IP addresses start at their correct initial IP address of 169.254.0.1 and then properly increment in accordance with the translated program 800 to 169.254.0.2 (as shown in data block 914). Thus, a new device is searched for and possibly identified at IP address 169.254.0.2; if identified, its identification information is printed out. Accordingly, the Big Endian source and/or intermediate code has been properly translated by the source-transparent endian translator to add appropriate swap byte order instructions in order to swap the byte order of a multi-byte data transfer as shown in program 800 of FIG. 8 such that the Big Endian source and/or intermediate code has been properly translated into Little Endian intermediate code, which is then further compiled into Little Endian machine code for use on a Little Endian processor, such that the Little Endian processor gives the correct output as has been shown.

As previously discussed, with reference to the example program 800 of FIG. 8, the implementation of the ip.value++ command 812 in code section 810 is the only section of code in the example that encounters the endian issue other than the code in section 822. It should be appreciated by those skilled in the art, however, that an optimized compiler may implement the endian fix using a INC DWRD PTR [ESI] command (e.g. increment a double word pointed to by an ESI register value), but typically implementing the endian fix requires that multi-byte arithmetic operations like this be deconstructed to their constituent parts so that some form of endian re-ordering is allowed (e.g. swapping operations). In this example, the BSWAP (e.g. byte swap) instruction was used, but other methods and/or instructions such as an ROR (rotate operand right) instruction or an XCHG (exchange) instruction, or any suitable instruction, may also be used. The deconstructing of a complex instruction into its constituent parts invokes a slight performance penalty. Of course, the actual amount of performance penalty will vary depending on the specifics of the application. However, it should be appreciated that the superior performance of some processors can typically more than make up for the performance degradation required by this adaption.

Further, it should be noted that the original commands of the source and/or intermediate code of program 800 (as shown in FIG. 8) did not have to change at all for this adaption from Big Endian format to Little Endian format to take place. Rather than moving the program to a Little Endian memory model, this approach retains the Big Endian memory model, even on Little Endian processors. Instead, in one embodiment, the source-transparent endian translator of the compiler merely adds an extra stage of swapping instructions after the symbolic object/assembly code has been emitted but before final optimization occurs. In this stage, the source-transparent endian translator of the compiler analyzes the code to identify multi-byte register-memory (or memory-arithmetic) operations and adds the appropriate swapping code as necessary. For example, the Big Endian mode could be a compiler switch that can be set in an environment variable or a makefile.

Advantageously, the source-transparent endian translator and the functionality performed by it, according to embodiments of the invention, as previously discussed, works across the board and does not need artificial intelligence algorithms to guess the intent of the programmer; this approach avoids the pitfalls common to the complex algorithms attempting to analyze data accesses. Further, no modification of the original commands of the source code is required at all. Also, the Big Endian memory model is maintained, which may be significant for support silicon designed to work with Big Endian processors. Additionally, it should be appreciated that the functionality of the source-transparent endian translator may easily be configured to work in reverse such that Big Endian processors may run Little Endian code, as well. Moreover, the functions of the source-transparent endian translator, as previously discussed, are fairly simple to implement in both compilers and debuggers. Also, as will be discussed in more detail later, in some embodiments, a specialized swap prefix instruction may be part of the instruction set architecture of the processor itself to gain even more efficiency.

As should be appreciated by those of skill in this art, additional code may be required to interface the code required to implement the functionality of the source-transparent endian translator with true Little Endian code, such as operating system calls or integration into third-party middle-ware. For example, special interposer routines may be needed to integrate the code associated with the functionality of the source-transparent endian translator, and some buffer copying may be required. An alternative approach may be to recompile everything (including the operating system(OS)) with the source-transparent endian translator so that everything operates in Big Endian mode. Further, it should be appreciated that some data structures that are directly walked by the microcode should always be stored in Little Endian mode. For example, in one embodiment, this includes paging tables, GDT, IDT, LDT, and TSS data structures, but these are very processor-specific and are not typically directly accessed by applications. Also, routines that manipulate these data structures will require interposer functions to ensure correct endianness. This may be necessary to avoid requiring any microcode changes.

As previously discussed, the functionality of the source-transparent endian translator operates consistently with respect to all multi-byte reads or writes. However, some optimizations may be added to the functionality of the source-transparent endian translator, which may yield some slight performance enhancements. For example, typically, constant values are either used with memory operations or with registers. In one embodiment, constants that are used with simple memory operations (e.g. MOV DWRD PTR [ESI], 12345678) may be pre-converted by the compiler to be in Big Endian mode by default (e.g. MOV DWRD PTR [ESI], 78563412) so that additional conversions are not necessary. Similarly, constants used with registers can be defined in Little Endian mode and do not need byte swapping.

Further, depending on the engineering practices in use with the Big Endian code, it may be advantageous to exempt pointers from requiring byte swapping. Particularly, if it is determined that the code at issue does not need any type of conversions between pointers and other data types, all pointer values may be exempted from byte swapping. In a similar vein, if a coding practice is consistently enforced of not accessing variables passed to functions directly off the stack, it may be possible to avoid having to swap bytes for variables passed to internal routines. This approach for endian translation can be more generally applied to type conversions between entities of the same length. For example, different processors may store floating point numbers in different formats, but the approach shown herein for endian translation can be applied to type conversion, albeit with additional complexity beyond a typical byte swap. While embodiments of the invention for source-transparent endian translation generally work when universally applied across all floating-point data, one possible optimization may be to natively support Little Endian ordering for floating point data. Either method will work as long as it is consistently applied across the system.

It may be desirable to separate out the memory and I/O spaces via a compiler option if memory needs the translation but I/O doesn't, or vice-versa.

In some embodiments, a specialized swap prefix instruction may be part of the instruction set architecture of the processor itself for even more efficiency. For example, the swap prefix would allow any memory or I/O access to have an endian conversion done on the fly in the processor or chipset. This would eliminate performance bottlenecks and would eliminate the need to bring memory into a register for swapping before any arithmetic operations could occur on the data before being written back out to memory. This would also allow direct arithmetic operations on multiple-byte memory locations with little to no performance hit.

With reference now to FIG. 10, FIG. 10 is an example of an instruction to aid in source-transparent endian translation the may be implemented as part of an instruction set within a processor, according to one embodiment of the present invention. As shown in FIG. 10, code block 1002 corresponds to the ip.value++ instruction 812 previously discussed with reference to program 800 of FIG. 8. In one embodiment of the invention, code block 1002 may be replaced by code block 1004 in which the ip.value++ instruction 812 is replaced by the ip.value++ instruction 1006, which includes a SWAP prefix that is an endian-swapping prefix for the next instruction. As previously discussed, the SWAP prefix would allow any memory or I/O access to have an endian conversion done on the fly in the processor or chipset. For example, the SWAP prefix may be implemented as part of an instruction set within the processor and may be implemented in hardware or in microcode.

While embodiments of the present invention and its various functional components have been described in particular embodiments, it should be appreciated the embodiments of the present invention can be implemented in hardware, software, firmware, middleware or a combination thereof and utilized in systems, subsystems, components, or sub-components thereof. When implemented in software or firmware, the elements of the present invention are the instructions/code segments to perform the necessary tasks. The program or code segments can be stored in a machine readable medium (e.g. a processor readable medium or a computer program product), or transmitted by a computer data signal embodied in a carrier wave, or a signal modulated by a carrier, over a transmission medium or communication link. The machine-readable medium may include any medium that can store or transfer information in a form readable and executable by a machine (e.g. a processor, a computer, etc.). Examples of the machine-readable medium include an electronic circuit, a semiconductor memory device, a ROM, a flash memory, an erasable programmable ROM (EPROM), a floppy diskette, a compact disk CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, bar codes, etc. The code segments may be downloaded via networks such as the Internet, Intranet, etc.

Further, while embodiments of the invention have been described with reference to illustrative embodiments, these descriptions are not intended to be construed in a limiting sense. Various modifications of the illustrative embodiments, as well as other embodiments of the invention, which are apparent to persons skilled in the art to which embodiments of the invention pertain, are deemed to lie within the spirit and scope of the invention.

What is claimed is:

1. An apparatus comprising:
a compiler to receive Big Endian source code that is operable on a processor that operates in a Big Endian mode; and
a source-transparent endian translator to work with the compiler to translate the Big Endian source code received by the compiler into a Little Endian code format, the Little Endian code format to be further processed by the compiler into Little Endian machine code that is operable on a processor that operates in a Little Endian mode.

2. The apparatus of claim 1, wherein, the source-transparent endian translator determines if the Big Endian source code involves a data transfer or manipulation between a register and a memory location.

3. The apparatus of claim 1, wherein, the source-transparent endian translator determines if the Big Endian source code involves an Input/Output (I/O) access.

4. The apparatus of claim 2, wherein, the source-transparent endian translator determines if the data transfer of the Big Endian source code involves a multi-byte data transfer.

5. The apparatus of claim 4, wherein, if the data transfer of the Big Endian source code involves a multi-byte data transfer, the byte order of the data being transferred is swapped.

6. The apparatus of claim 5, wherein, one or more swap byte order instructions are added to the Big Endian source code in order to swap the byte order of the data being transferred.

7. The apparatus of claim 5, further comprising, a processor to operate the compiler, the processor including one or more instructions as part the processor's instruction set to swap the byte order of the data being transferred.

8. The apparatus of claim 1, wherein the Little Endian code format from the source-transparent endian translator is Little Endian intermediate code, the Little Endian intermediate code being further compiled into Little Endian machine code.

9. The apparatus of claim 1, wherein the source-transparent endian translator translates the Big Endian source code received by the compiler into a Little Endian code format without modifying the original commands of the Big Endian source code.

10. The apparatus of claim 1, wherein the compiler is an interpreter.

11. A method comprising:
receiving Big Endian source code that is operable on a processor that operates in a Big Endian mode;
translating the Big Endian source code into a Little Endian code format; and
compiling the Little Endian code format into Little Endian machine code that is operable on a processor that operates in a Little Endian mode, while still retaining Big Endian format in memory.

12. The method of claim 11, further comprising determining if the Big Endian source code involves a data transfer between a register and a memory.

13. The method of claim 11, further comprising determining if the Big Endian source code involves an Input/Output (I/O) access.

14. The method of claim 12, further comprising determining if the data transfer of the Big Endian source code involves a multi-byte data transfer.

15. The method of claim 14, wherein, if the data transfer of the Big Endian source code involves a multi-byte data transfer, further comprising swapping the byte order of the data being transferred.

16. The method of claim 15, further comprising adding one or more swap byte order instructions to the Big Endian source code in order to swap the byte order of the data being transferred.

17. The method of claim 11, wherein the Little Endian code format from the source-transparent endian translator is Little Endian intermediate code, further comprising compiling the Little Endian intermediate code into Little Endian machine code.

18. The method of claim 11, wherein compiling includes interpreting.

19. The method of claim 11, wherein the Big Endian source code that is translated into a Little Endian code format, is translated into the Little Endian code format without modifying the original commands of the Big Endian source code.

20. A machine-readable medium having stored thereon instructions, which when executed by a machine, cause the machine to perform the following operations comprising:
receiving Big Endian source code that is operable on a processor that operates in a Big Endian mode;
translating the Big Endian source code into a Little Endian code format; and
compiling the Little Endian code format into Little Endian machine code that is operable on a processor that operates in a Little Endian mode.

21. The machine-readable medium of claim 20, further comprising determining if the Big Endian source code involves a data transfer between a register and a memory.

22. The machine-readable medium of claim 20, further comprising determining if the Big Endian source code involves an Input/Output (I/O) access.

23. The machine-readable medium of claim 21, further comprising determining if the data transfer of the Big Endian source code involves a multi-byte data transfer.

24. The machine-readable medium of claim 23, wherein, if the data transfer of the Big Endian source code involves a multi-byte data transfer, further comprising swapping the byte order of the data being transferred.

25. The machine-readable medium of claim 24, further comprising adding one or more swap byte order instructions to the Big Endian source code in order to swap the byte order of the data being transferred.

26. The machine-readable medium of claim 20, wherein the Little Endian code format from the source-transparent endian translator is Little Endian intermediate code, further comprising compiling the Little Endian intermediate code into Little Endian machine code.

27. The machine-readable medium of claim 20, wherein compiling includes interpreting.

28. The machine-readable medium of claim 10, wherein the Big Endian source code that is translated into a Little Endian code format, is translated into the Little Endian code format without modifying the original commands of the Big Endian source code.

29. A computer system for compiling software comprising:
a processor;
a dynamic random access memory (DRAM) coupled to the processor;
a compiler operable by the processor to receive Big Endian source code that is operable on a processor that operates in a Big Endian mode; and
a source-transparent endian translator to translate the Big Endian source code received by the compiler into a Little Endian code format, the Little Endian code format to be further processed by the compiler into Little Endian machine code that is operable on a processor that operates in a Little Endian mode.

30. The computer system of claim 29, wherein, the source-transparent endian translator determines if the Big Endian source code involves a data transfer between a register and a memory.

31. The computer system of claim 29, wherein, the source-transparent endian translator determines if the Big Endian source code involves an Input/Output (I/O) access.

32. The computer system of claim 30, wherein, the source-transparent endian translator determines if the data transfer of the Big Endian source code involves a multi-byte data transfer.

33. The computer system of claim 32, wherein, if the data transfer of the Big Endian source code involves a multi-byte data transfer, the byte order of the data being transferred is swapped.

34. The computer system of claim 33, wherein, one or more swap byte order instructions are added to the Big Endian source code in order to swap the byte order of the data being transferred.

35. The computer system of claim 33, wherein the processor includes an instruction as part the processor's instruction set to swap the byte order of the data being transferred.

36. The computer system of claim 29, wherein the Little Endian code format from the source-transparent endian translator is Little Endian intermediate code, the Little Endian intermediate code being further compiled into Little Endian machine code.

37. The computer system of claim 29, wherein the source-transparent endian translator translates the Big Endian source code received by the compiler into a Little Endian code format without modifying the original commands of the Big Endian source code.

38. A method comprising:
receiving Little Endian source code that is operable on a processor that operates in a Little Endian mode;
translating the Little Endian source code into a Big Endian code format; and
compiling the Big Endian code format into Big Endian machine code that is operable on a processor that operates in a Big Endian mode, while still retaining Little Endian format in memory.

39. The method of claim 38, further comprising determining if the Little Endian source code involves a data transfer between a register and a memory.

40. The method of claim 38, further comprising determining if the Little Endian source code involves an Input/Output (I/O) access.

41. The method of claim 39, further comprising determining if the data transfer of the Little Endian source code involves a multi-byte data transfer.

42. The method of claim 41, wherein, if the data transfer of the Little Endian source code involves a multi-byte data transfer, further comprising swapping the byte order of the data being transferred.

43. The method of claim 42, further comprising adding one or more swap byte order instructions to the Little Endian source code in order to swap the byte order of the data being transferred.

44. An apparatus comprising:
a compiler to receive first source code having a first data type in a first format that is operable on a processor that operates in a first data type mode; and
a source-transparent translator to work with the compiler to translate the first source code in the first format received by the compiler into a second data type in a second format in a manner transparent to the first source code to yield a second source code format, the second source code format to be further processed by the compiler into machine code that is operable on a processor that operates in a second data type mode.

45. The apparatus of claim 44, wherein, the source-transparent translator determines if the first source code involves a data transfer or manipulation between a register and a memory location.

46. The apparatus of claim 44, wherein, the source-transparent translator determines if the first source code involves an Input/Output (I/O) access.

47. The apparatus of claim 45, wherein, the source-transparent translator determines if the data transfer of the first source code involves a multi-byte data transfer.

48. The apparatus of claim 47, wherein, if the data transfer of the first source code involves a multi-byte data transfer, the byte order of the data being transferred is swapped.

49. The apparatus of claim 48, wherein, one or more swap byte order instructions are added to the first source code in order to swap the byte order of the data being transferred.
